(19) United States
(12) Patent Application Publication
(10) Pub. No.: US 2022/0187969 A1
(43) Pub. Date: Jun. 16, 2022

(54) Optimizing Service Delivery through Partial Dependency Plots

(71) Applicant: Cerner Innovation, Inc., Kansas City, KS (US)

(72) Inventors: Darshan Matada Shashidhara, Bangalore (IN); Arpit Munjal, Jaipur (IN); Amarrtya Jana, Kolkata (IN); Srikant Kumar, Jharkhand (IN); Akshata Dasar, Hubli (IN); Pramod Kumar Deshpandey, Bangalore IN (IN)

(21) Appl. No.: 17/121,290

(22) Filed: Dec. 14, 2020

(51) Int. Cl. G06F 3/0488; G06F 3/0482; G06F 3/01; G06N 20/20

(52) U.S. Cl. CPC G06F 3/0488; G06N 20/20; G06F 3/016; G06F 3/0482

(57) ABSTRACT

This disclosure includes technologies for service level delivery, including for achieving various threshold satisfaction levels in delivering services. The disclosed system uses machine learning models to predict the respective importance of various variables associated with a service. Further, the disclosed system determines respective marginal contributions and respective thresholds associated with variables with high-impact for service level delivery. Subsequently, the disclosed system performs various tasks based on those thresholds to achieve various threshold satisfaction levels in delivering the service.

### BACKGROUND

Customers generally have some service level delivery (SLD) expectations of an information technology (IT) system. SLD may be expressed in specific service level metrics (SLMs) for a particular IT system. For example, SLMs for an Internet service provider (ISP) may include a minimum download speed, a minimum upload speed, a maximum downtime, a maximum error rate, a maximum latency, etc. As another example, SLMs for a cloud computing system may include availability (e.g., the ratio of the actual function time of the system to the total expected function time), load (e.g., the percentage of workload to the total system capacity), reliability (e.g., mean time between failures, mean time to repair, etc.), security (e.g., access control, data integrity, confidentiality, etc.), etc.

SLD is a crucial component in a service-level agreement (SLA) between a service provider and a customer. Service providers are often challenged to meet the SLD requirements in the SLAs. Conventional IT systems try to meet the SLD requirements by way of overprovisioning, for example, by allocating extra computer data storage space, additional network bandwidth, backup supporting staff, etc. One issue of overprovisioning is waste because the overprovisioned resources are typically seldom utilized. Another more fundamental problem is that overprovisioning a particular resource may not necessarily help the provider meet a specific SLD requirement. This problem is more acute when the service level metric (SLM) becomes more sophisticated, e.g., customer satisfaction or dissatisfaction. Conventional IT systems generally are not able to provide SLD associated with such sophisticated SLMs.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, this disclosure includes a technical solution for determining and maintaining the service level delivery (SLD) of an information technology (IT) system, especially via a partial dependence plot (PDP). In various embodiments, the disclosed system determines a feature (e.g., turnaround time (TAT)) having a high-impact on a service level metric (SLM) (e.g., a composite SLM of user satisfaction or dissatisfaction) via machine learning on SLD data. Subsequently, the disclosed system predicts a marginal contribution of the feature to the SLM via a PDP. A target SLM level may then be determined via the PDP by a user or automatically by the disclosed system without user intervention. Based on the threshold of the high-impact feature corresponding to the target SLM level, the disclosed system intelligently execute various system regulation tasks to regulate the SLD of the IT system based on the threshold. Such system regulation tasks include generating an alert, displaying such alert via an improved graphical user interface (GUI), regulating service queues, regulating service resources, etc.

Furthermore, various systems, methods, and computer-readable storage devices are disclosed to improve the SLD of an IT system in various aspects. Specifically, one technical purpose is to determine the threshold of the high-impact feature corresponding to the target SLM level. Among the many aspects of technical characters described herein to achieve the aforementioned technical purpose, one aspect of the technical characters includes using machine learning models and historical SLD data to discover the high-impact feature related to the SLM. Another aspect of the technical characters includes using the PDP to predict the marginal contribution of the feature to the SLM. Yet another aspect of the technical characters includes determining the target SLM level and the threshold of the high-impact feature corresponding to the target SLM level via the PDP. These technical characters lead to further technical effects, including various improved GUIs for SLD and various improved system regulation functions to regulate the SLD with the threshold of the high-impact feature. Various other improvements over conventional IT systems are further discussed in the Detailed Description.

### BRIEF DESCRIPTION OF THE DRAWINGS

The technologies described herein are illustrated by way of example and not limited by the accompanying figures in which like reference numerals indicate similar elements and in which:

FIG. 1 is a schematic diagram of an exemplary system, in accordance with at least one aspect of the technologies described herein;

FIG. 2 depicts a matrix and associated metrics relating to a prediction model, in accordance with at least one aspect of the technologies described herein;

FIG. 3 illustrates an exemplary process to prepare data for generating a partial dependence plot, in accordance with at least one aspect of the technologies described herein;

FIG. 4 illustrates an exemplary process to determine a feature threshold via a partial dependence plot, in accordance with at least one aspect of the technologies described herein;

FIG. 5 depicts other forms of partial dependence plots, in accordance with at least one aspect of the technologies described herein;

FIG. 6 shows exemplary graphical user interfaces for displaying alerts, in accordance with at least one aspect of the technologies described herein;

FIG. 7 depicts flow diagrams illustrating exemplary processes of service level delivery through partial dependence plots, in accordance with at least one aspect of the technologies described herein; and

FIG. 8 is a block diagram of an exemplary computing environment suitable for implementing various aspects of the technologies described herein.

### DETAILED DESCRIPTION

The various technologies described herein are set forth with sufficient specificity to meet statutory requirements. However, the description itself is not intended to limit the scope of this disclosure. Instead, the inventors have contemplated that the claimed subject matter might also be embodied in other ways, to include different steps or combinations of steps similar to the ones described in this document, in conjunction with other present or future technologies. Moreover, although the terms “step” or “block” may be used herein to connote different elements of methods employed, the terms should not be interpreted as implying any particular order among or between various steps herein disclosed unless and except when the order of individual steps is explicitly described. Further, the term “based on” generally denotes that the succedent object, data, or information is used in performing the precedent action.

Regarding the use of singular and plural, we do not mean to intend any sort of strict numerical implication by using the singular or plural of a term, similar to our lack of intent to imply the singular by using “a” or “the.” Trying to capture the plural in words or in the figures would often lead to wordiness. For example, though we might refer to “a database,” clearly, we fully anticipate that such reference would be equally applicable to multiple databases or, more generally, to data stores. By way of another example, “a memory” does not imply one single memory device.

As one skilled in the art will appreciate, embodiments of our invention may be embodied as, among other things: a method, system, or set of instructions embodied on one or more computer-readable media. Accordingly, the embodiments may take the form of a hardware embodiment, a software embodiment, or an embodiment combining software and hardware. In one embodiment, the invention takes the form of a computer-program product that includes computer-usable instructions embodied on one or more computer-readable media.

Computer-readable media include both volatile and nonvolatile media, removable, non-removable media, and contemplate media readable by a database, a switch, and various other network devices. By way of example, and not limitation, computer-readable media comprise media implemented in any method or technology for storing information, including computer-storage media and communications media. Examples of stored information include computer-usable instructions, data structures, program modules, and other data representations. Computer storage media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, other magnetic storage devices, and other storage devices. These technologies can store data momentarily, temporarily, or permanently.

SLD is a crucial component in an SLA between a service provider and a user. Service providers are often challenged to meet the SLD requirements in the SLAs. Conventional IT systems usually try to meet the SLD requirements by way of overprovisioning, for example, by allocating extra computer data storage space, additional network bandwidth, backup supporting staff, etc. One issue of overprovisioning is waste because the overprovisioned resources are typically seldom utilized. Another more fundamental problem is that overprovisioning a particular resource may not necessarily help the provider meet a specific SLD requirement.

SLD requirements are often expressed in various service level metrics (SLMs). Some SLMs are event-oriented performance criteria (e.g., availability). Some SLMs are quantity-oriented performance criteria (e.g., throughput). Some SLMs are quality-oriented performance criteria (e.g., correctness, error rate, etc.). Other SLMs relating to a mix of event, quantity, and quantity (e.g., user satisfaction or dissatisfaction) are more sophisticated and composite. For example, one composite SLM may include many parameters, which by themselves are different SLMs. Conventional IT systems generally are not able to provide SLD associated with such sophisticated SLMs.

Sophisticated SLMs, such as user satisfaction or dissatisfaction, are hard to understand and predict because an IT system usually has a diverse set of users crossing different geographies, solutions, roles, ages, genders, cultures, needs, expectations, familiarity levels to the IT system, etc. On the other hand, sophisticated SLMs, such as user satisfaction or dissatisfaction, are composite. For example, user satisfaction for an IT system may include many simpler SLMs. Accordingly, the driving factors behind user satisfaction or dissatisfaction can diverge and change. By way of example, the IT system opens a service ticket when any user encounters a technical issue. However, some users may expect quick closure of their tickets while others expect frequent updates of their tickets. Some users expect a single point of contact (POC) (i.e., an IT specialist owns the ticket from the opening to the closure) while other users do not care about ownership change of their tickets. Accordingly, it is difficult to understand the specific driving factor, if any, for different users or different segments of users.

In attempting to provide SLD associated with user satisfaction, some conventional IT systems would blindly target to achieve a higher level of service on one SLM (e.g., TAT) while comprising another SLM (e.g., single POC). There are many deficiencies for such brute-force approaches. To name a few, the user satisfaction driving SLM for some users could be POC instead of TAT. Further, the dreaded customer satisfaction plateau usually would kick in for any simpler SLM. For example, regardless of how hard the IT system continuously improves TAT, user satisfaction wouldn't improve forever after a certain point. In short, conventional IT systems are ineffective and inefficient for handling SLD associated with sophisticated or composite SLMs.

Further, user satisfaction or dissatisfaction is vital for some mission-critical IT systems, such as health care IT systems or emergency-response IT systems. For example, users for a health care IT system include clinicians, administrators, staff, etc. The user satisfaction level of the health care workers reflects the effectiveness of the underlying health care IT system to empower the health workers in diagnosing and treating diseases or even saving or prolonging lives. There is an urgent need to improve conventional technologies for SLD associated with sophisticated or composite SLMs.

In brief and at a high level, this disclosure describes, among other things, methods, systems, computer storage media, and graphical user interfaces for improving an IT system's SLD associated with sophisticated or composite SLMs, especially user satisfaction or dissatisfaction. The present disclosure improves prior art systems by using a data-driven approach to determine the threshold of a lower-level or singular SLM (also known as “feature” or “parameter” in this disclosure, e.g., TAT, responsiveness, etc.) corresponding to the target level of a higher-level or composite SLM (e.g., user satisfaction or dissatisfaction). Based on such thresholds, the disclosed system may regulate or maintain the IT system's SLD at the target level of the composite SLM.

In various embodiments, the disclosed system determines a high-impact feature on the composite SLM (e.g., user satisfaction or dissatisfaction) via machine learning on SLD data (e.g., historical user feedback data). Subsequently, the disclosed system predicts a marginal contribution of the high-impact feature to the SLM via a PDP. A target SLM level may then be determined via the PDP by a user or automatically by the disclosed system without user intervention. Based on the threshold of the high-impact feature corresponding to the target SLM level, the disclosed system intelligently execute various system regulation tasks to regulate the SLD of the IT system based on the threshold. Such system regulation tasks include generating an alert, causing the display of the alert via an improved graphical user interface (GUI), regulating service resources, regulating service queues, etc.

As discussed, one technical purpose is to determine the threshold of the high-impact feature corresponding to the target SLM level. Among the many aspects of technical characters described herein to achieve the aforementioned technical purpose, one aspect of the technical characters includes using machine learning models and historical SLD data to discover the high-impact feature related to the SLM. Another aspect of the technical characters includes using the PDP to predict the marginal contribution of the feature to the SLM. Yet another aspect of the technical characters includes determining the target SLM level and the threshold of the high-impact feature corresponding to the target SLM level via the PDP. These technical characters lead to further technical effects, including various improved GUIs for SLD and various improved system regulation functions to regulate the SLD with the threshold of the high-impact feature. Detailed discussions of these technical characters are provided in connection with various figures and embodiments disclosed herein.

Each of the disclosed embodiments improves conventional systems in terms of their deficiencies, ineffectiveness, or inefficiencies. For example, many settings in conventional systems are driven by intuition and isolated feedback on incidents. However, intuition is unreliable, and it is difficult to find a trend or distill system knowledge based on isolated feedback on incidents. Resultantly, conventional systems may mistakenly prioritize trivial SLMs that do not really matter to users. As an improvement, by differentiating high-impact features with low-impact features based on machine learning with historical SLD data, the disclosed system can prioritize proper drivers to user satisfaction and deprioritize features that only have a trivial impact on user satisfaction.

Further, conventional systems may arbitrarily set up a target SLM level. As an improvement, the disclosed system can intelligently determine the target SLM level, e.g., based on the marginal contribution of the feature to the SLM, e.g., as shown in the PDP. Resultantly, the disclosed system can avoid setting unreasonable target SLM levels, which cannot be achieved even with unlimited resources, unreasonable to achieve with limited resources, or unnecessary to achieve with or without unlimited resources.

More importantly, conventional systems set a blanket system-wide feature threshold (e.g., TAT threshold) across all segments of users. However, the blanket feature threshold may lead to a wide fluctuation in user satisfaction levels. Accordingly, conventional systems will not be able to deliver services with a consistent user satisfaction level. As an improvement, by determining respective thresholds for different segments of users relating to a common high-impact feature (e.g., TAT) corresponding to a target SLM level (e.g., the 0.2 level of dissatisfaction) in the PDP, the disclosed solution enables the IT system to maintain a consistent level of user satisfaction across different segments of users.

Advantageously, the disclosed solution further includes many new system features or functions for SLD, e.g., based on the respective thresholds of one or more high-impact features. By way of example, the disclosed system provides alerts at the service instance level, e.g., a ticket, an incident, an event, etc., which is at risk of threshold breaching, and ensure the IT system to meet the SLD requirement. For instance, an alert may be generated and delivered to a ticket owner when the ticket's responsiveness threshold is going to be breached, e.g., within one, two, or three days, so that the ticket owner can provide an update on the ticket to ensure the target level of customer satisfaction. As discussed in various embodiments below, the alert may be integrated with an improved GUI so that the ticket owner or the system operator can view or review such alerts at the proper time and conveniently identify the relationship between the alert and the affected service instance(s).

Further, the disclosed system is configured to regulate resources to meet the SLD requirement. Such resources include computing resources (e.g., virtual servers, computing priority, computer memory, etc.) and human resources (e.g., service specialists, techniques, etc.). Conventional systems typically make provisioning decisions based on average service instances or needs and manually adjust resources in response to an emergency (e.g., a spike of service requests). As such, conventional resource allocation techniques lead to overprovisioning or waste at regular times and underperformance during high demands. In contrast, the disclosed system is configured to dynamically allocate or reallocate an appropriate amount of computing or human resources to at-risk service queues or service instances for preventing them from breaching a feature threshold of, e.g., TAT, time to first response, etc. Resultantly, IT systems implementing the disclosed technologies use overall fewer resources to handle overall more demands while maintaining the SLD with regard to the target SLM level.

Even further, by generating alerts for service instances at the appropriate time and appropriate place in the GUI, the disclosed solution enables operators of the IT system to make correct and timely operation decisions to achieve the target SLM level, such as setting priorities for different service instances, determining the appropriate timing to contact customers, determining whether to change ownership of a service instance, etc. For example, with the disclosed system, an operator is now better equipped to mitigate a situation or alert when a threshold breach is on the verge. Further, after reviewing alerts, the operator now knows when to reach out to a customer and diffuse the underlying issue before breaching a threshold.

Additionally, the disclosed technologies are generally applicable to many IT systems, including health care systems, emergency-response systems, ISP systems, telecommunication systems, online game system, or any IT systems with customer services. The disclosed technologies can improve SLD for these IT systems. Further, apart from the aforementioned technical advantages, operators of IT systems implementing the disclosed technologies will improve their operating margins and provide better costing compared to their competitors.

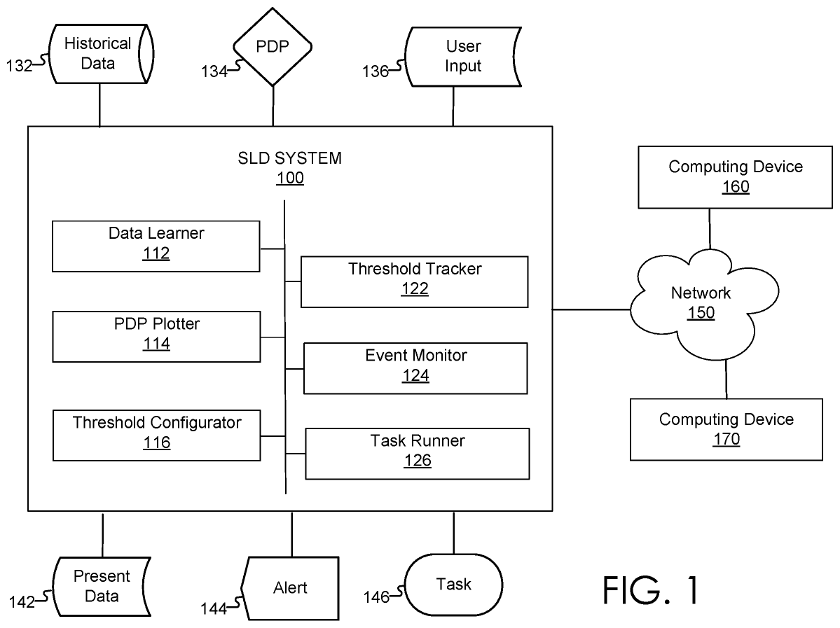

Having briefly described an overview of the technologies described herein, referring now to FIG. 1, which is a schematic diagram of an exemplary system for service level delivery (SLD) through partial dependence plots (PDPs). With reference to FIG. 1, in this embodiment, SLD system 100 includes various components, including data learner 112, PDP plotter 114, threshold configurator 116, threshold tracker 122, event monitor 124, and task runner 126. These components collectively implementing the disclosed technologies for SLD based on PDPs so that SLD system 100 can enable an IT system to achieve a target level of SLM, e.g., a specific user satisfaction level.

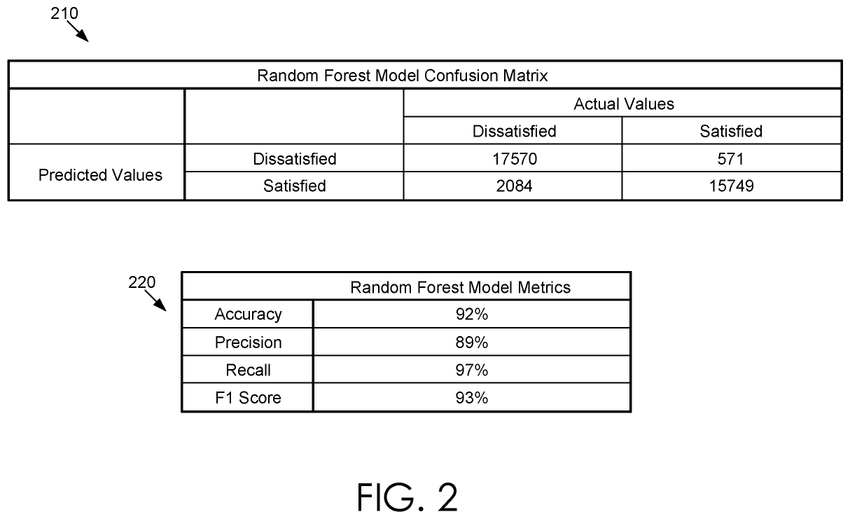

At a high level, data learner 112 uses machine learning techniques and historical data 132 to determine features that have a high impact on an SLM, e.g., user satisfaction or dissatisfaction. Historical data 132 may include many features that potentially have some level of impact on the SLM. As further discussed in connection with FIG. 2, an ensemble learning method for classification is used in some embodiments to differentiate a high-impact feature from a low-impact feature.

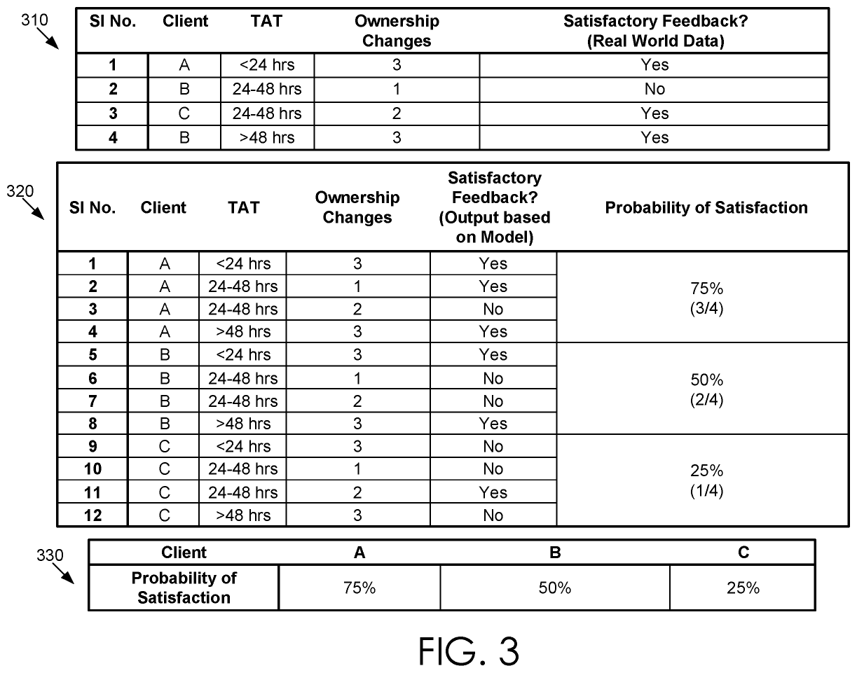

In various embodiments, PDP plotter 114 plots PDPs for one or more high-impact features with respect to the SLM. A PDP shows the marginal effect one or two features have on the predicted outcome of a machine learning model. The PDP (e.g., PDP 134) is displayed for user review in some embodiments. In other embodiments, PDP plotter 114 directly passes the data of PDP 134 to threshold configurator 116. An embodiment of making PDP plots are further discussed with FIG. 3.

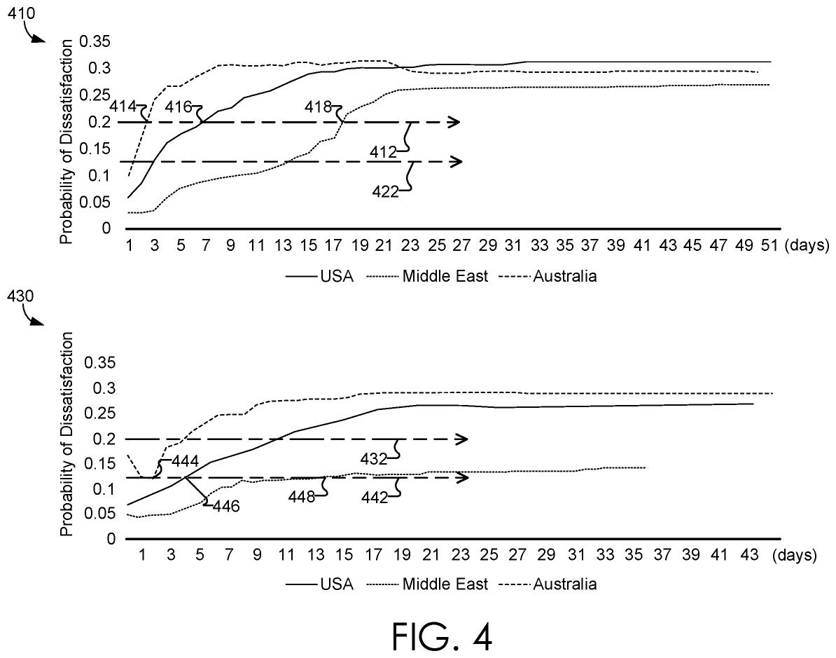

Threshold configurator 116 can receive user input 136 regarding the target SLM level, the feature threshold, etc., after an operator of the IT system reviews PDP 134. In alternative embodiments, threshold configurator 116 is configured to determine a target SLM level, a feature threshold corresponding to the target SLM level, etc., directly using the PDP data without user intervention. Various embodiments relating to threshold configurator 116 are further discussed with FIG. 4.

For the same target SLM level, different segments of users may have different corresponding feature thresholds. In various embodiments, threshold configurator 116 also determines a harmonized feature threshold from applicable feature thresholds related to a diverse institutional user, e.g., when the institutional user has multiple segments of users. Some aspects of this harmonization process are further discussed with FIG. 4.

Threshold tracker 122, event monitor 124, and task runner 126 are configured to regulate the IT system to achieve the target SLM level based on present data 142 and the feature threshold corresponding to the target SLM level. Specifically, threshold tracker 122 is configured to track respective feature thresholds as determined by threshold configurator 116. For example, threshold tracker 122 tracks respective thresholds for a common feature for different segments of users. As another example, threshold tracker 122 tracks respective feature thresholds of different features corresponding to a target SLM level. As yet another example, threshold tracker 122 tracks feature thresholds for different users.

Meanwhile, event monitor 124 is configured to monitor the status of service instances and to trigger task runner 126 to perform various tasks, e.g., in view of a potential threshold breach event. Task runner 126 is configured to generate or display alert 144 or perform task 146, which could be any one of the regulation tasks as discussed in connection with various embodiments, such as dynamically regulating resources based on present data 142 and the feature threshold corresponding to the target SLM level.

In one embodiment, computing device 160 and computing device 170 are configured to serve different service queues in the IT system. For example, computing device 160 and computing device 170 are two virtual serves in a computing cloud, and computing device 160 and computing device 170 are commissioned to serve different service queues or users, e.g., two different hospitals or two regions with each region covering one or more hospitals. In view of a potential threshold breach with computing device 160, task runner 126 may dynamically redistribute computing resources from computing device 170 to computing device 160 to boost the capacity and performance of computing device 160, so that the risk of threshold breach with computing device 160 may be quenched.

For instance, computing device 160 and computing device 170 may share computational resources (e.g., CPUs, GPUs, memory, storage, bandwidth, etc.) for running various deep learning models for medical diagnostics with computed tomography (CT) or magnetic resonance imaging (MRI) imaging data. A surge of diagnostic requests to computing device 160 alone does not necessarily warrant a redistribution of shared computational resources. For example, computing device 160 may still be capable of running all tasks just for a longer time. However, when event monitor 124 notices that one or more feature thresholds might breach due to the surge of diagnostic requests, event monitor 124 may request task runner 126 to execute a resource redistribution task to prevent such feature threshold breach from happening so that computing device 160 can maintain the target SLM level.

SLD system 100 can connect to computing device 160, computing device 170, or other computing devices via network 150. In embodiments, network 150 includes the Internet and/or one or more public networks, private networks, other communications networks such as a cellular network, or similar network(s) for facilitating communication among devices connected through network 150. Network 150 may be determined based on factors such as the source and destination of the information communicated over network 150, the path between the source and destination, or the nature of the information. For example, intra-organization or internal communication may use a private network or virtual private network (VPN). Further, in some embodiments, SLD system 100 may include a firewall (not shown) to protect the integrity of various components discussed herein and prevent intrusions from network 150.

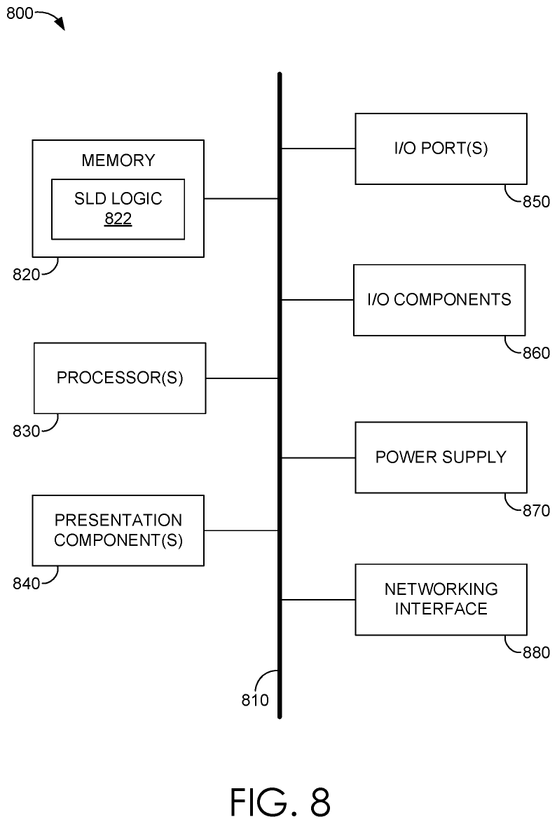

SLD system 100 is merely one example of a suitable computing environment and is not intended to suggest any limitation on the scope of use or functionality of aspects of the technologies described herein. Neither should this system be interpreted as having any dependency or requirement relating to any one component nor any combination of components illustrated. It should be understood that each of the components shown in SLD system 100 may be implemented on any type of computing device, such as computing device 800 described in FIG. 8. Different components in SLD system 100 may be distributed to different physical devices. Further, a component may communicate with another component or various external devices via a network, which may include, without limitation, a local area network (LAN) or a wide area network (WAN).

It should be understood that this arrangement in SLD system 100 is set forth only as an example. Other arrangements and components (e.g., machines, networks, interfaces, functions, orders, and grouping of functions, etc.) can be used in addition to or instead of those shown, and some elements may be omitted altogether for the sake of clarity. Further, many of the components described herein are functional entities that may be implemented as discrete or distributed components or in conjunction with other components, and in any suitable combinations and locations. Further, various functions described herein as being performed by a component may be carried out by hardware, firmware, or software. For instance, some functions may be carried out by a processor executing special instructions stored in memory, such as SLD logic 822 of FIG. 8.

Referring now to FIG. 2, which depicts a matrix and associated metrics relating to a prediction model based on an ensemble learning method for classification, specifically a random forest model in this embodiment. The target features in PDPs are typically one or two only; thus, the target features are usually chosen from high-impact features. The random forest model is used to select one or two high-impact features for constructing PDPs. The random forest model has a large number of individual decision trees that operate as an ensemble. Each individual tree in the random forest makes a prediction, and the most popular prediction among all decision trees becomes the final prediction. In some embodiments, the random forest model uses classification trees when the predicted outcome is a discrete class to which the data belongs. In some embodiments, the random forest model uses regression trees when the predicted outcome can be considered a real number (e.g., a patent's glucose level, a patient's length of stay in a hospital, etc.).

Regarding matrix 210, the random forest model uses classification trees to make the prediction between two discrete classes, namely, satisfied and dissatisfied from feedback data, e.g., in historical data 132 of FIG. 1. Specifically, feedback on a scale of 1 to 5 on thousands of closed tickets are used in this embodiment. A rating of 4 or above qualifies as being satisfied. These tickets have dozens of parameters, such as origin country, origin state, primary region/area, provider, TAT, phone/email communication, local time zone, number of ownership changes, responsiveness, etc.

In this embodiment, the random forest prediction model is being refined until the performance metrics, such as accuracy, precision, recall, and F1 score, as shown in table 220, reach a satisfactory level. As indicated by matrix 210, the random forest prediction model can predict accurately according to the ground truth. In other words, the predicted values generally become consistent with actual values in matrix 210. Different IT systems have different accuracy requirements. For a health care IT system, a high accuracy level is generally required.

In machine learning, ensemble methods use multiple learning algorithms to obtain better predictive performance than could be obtained from any of the constituent learning algorithms alone. A random forest classifier, as used in this embodiment, is a specific type of bootstrap aggregating decision trees, which builds multiple decision trees by repeatedly resampling training data with replacement and voting the trees for a consensus prediction. In other embodiments, different ensemble methods may be used, such as boosted trees or rotation forest trees. Further, the random forest prediction model, as used in this embodiment, is further used to reveal the impact or relative importance of a parameter or feature in relation to the predicted classes, which is also discussed with FIG. 4.

FIG. 3 illustrates an exemplary process to prepare data for generating a partial dependence plot. In general, a PDP shows the dependence between the target response and target features after marginalizing over the values of all other features. Alternatively, it may be said that the PDP can show the expected target response as a function of the target features. When plotted as a line graph, as shown in FIG. 4, the PDP shows the marginal contribution of the target feature with regard to the target response.

Data used for plotting PDPs may be calculated after the prediction model has been trained, e.g., with training data, as discussed in connection with FIG. 2. To understand the incremental impact of each high-impact feature, additional data may be generated based on the real-world data so that all permutations of the given data set with the given data feature is created and fed into the prediction model to capture its predicted output.

As an example, let us assume that the goal is to understand the driving factors of user satisfaction for users in different regions. Further, let us assume that the data set only contains four data points (1, 2, 3, and 4) and three features (Client, TAT, and Ownership changes), as shown in table 310. Table 310 also lists the feedback data from real-world data.

A new data set, with probabilities of satisfaction predicted from the prediction model, is generated in table 320 to determine how the feature of “Client” may impact user satisfaction. Here, the feature of “Client” has three unique instances, A, B, and C. Table 320 shows twelve predictions, and table 330 summarizes the probability of satisfaction for each Client instance. The data on table 330 may then be used to construct a PDP to show the marginal contribution of the Client feature with regard to the probabilities of satisfaction.

FIG. 4 illustrates an exemplary process to determine a threshold via a partial dependence plot. PDPs were introduced with the purpose of interpreting complex machine learning algorithms, e.g., to enhance our understanding of variable importance in a given model. In general, a PDP depicts the functional relationship between an input variable (i.e., the feature) and an output variable (i.e., the prediction). This functional relationship shows how the predictions partially depend on the values of the input variable of interest.

In various embodiments, different methods are used to measure parameter or feature importance with tree-based models. Important features are selected to generate respective PDPs. In some embodiments, techniques associated with Gini importance or mean decrease in impurity (MDI) are used with the random forest prediction model to guide feature selection and PDP engineering. Such techniques calculate each feature importance based on the total decrease in node impurity weighted by the probability of reaching that node, then further averaged over all decision trees. In other words, such methods are based on the times a feature is used to split a node, and the number of samples it splits. In some embodiments, methods of permutation importance or mean decrease in accuracy (MDA) are used to determine the feature importance. In other embodiments, other split-based or gain-based measures are used for feature selection for PDP generation.

In one embodiment, for one set of historical data of tickets in a health care IT system, the random forest prediction model revealed that the top three high-impact parameters are TAT, response time, and the number of owners. However, the measures are different for different regions, e.g., the Middle East region, Australia, and the U.S. In other embodiments, segments of users may be defined based on hospitals, service providers, diagnoses, etc., instead of regions in this embodiment.

The simplest PDPs are one-way plots, which show how a model's predictions depend on a single input variable. In various embodiments, to understand the marginal impact of each of the high-impact features on user satisfaction, respective PDPs are generated for each of the high-impact features. For example, PDP 410 is based on the feature of TAT, and PDP 410 illustrates the relationship between TAT and the probability of dissatisfaction, which is an inverse of the probability of satisfaction. As another example, PDP 430 is based on the feature of responsiveness (i.e., the average time between updates on a ticket), and PDP 430 illustrates the relationship between responsiveness and the probability of dissatisfaction. Further, each PDP contains three lines corresponding to three segments of users, namely, the USA, the Middle East, and Australia.

Referring now specifically to PDP 410, a reviewer may observe that the respective impacts of TAT on the probability of dissatisfaction are different for three segments of users. For example, intercepting line 412 corresponds to the 0.2 level of probability of dissatisfaction. Intercept 414 indicates about two days maximum of TAT is required to maintain the 0.2 level of probability of dissatisfaction for users in Australia, while intercept 416 indicates about six days maximum of TAT is required to maintain the same level of probability of dissatisfaction for users in the USA. In contrast, intercept 418 indicates users in the Middle East have greater patience, and it will generally take more than seventeen days of TAT to breach the 0.2 threshold.

Further, significant efforts are required to improve from the 0.2 level to the 0.13 level, which is represented by intercepting line 422. For example, the TAT threshold would need to be cut in half for users in Australia and the USA. However, the TAT threshold for users in the Middle East would only need to be reduced from about seventeen days to thirteen days.

Referring now specifically to PDP 430, a reviewer may observe that the respective impacts of responsiveness on the probability of dissatisfaction are also different for three segments of users. Intercepting line 432 corresponds to the 0.2 level of dissatisfaction. However, it appears that users in the Middle East will never reach the 0.2 level regardless of the time of responsiveness. Intercepting line 442 corresponds to the 0.13 level of probability of dissatisfaction. At the 0.13 level, intercept 444 indicates about two days maximum of responsiveness for users in Australia, while intercept 446 indicates about four days maximum of responsiveness is required to maintain the same level of probability of dissatisfaction for users in the USA. In contrast, intercept 448 indicates much longer responsiveness (about thirteen days) is required for users in the Middle East.

As such, based on the PDPs, a review can determine respective thresholds (e.g., the maximum time for TAT or responsiveness) for different segments of users (e.g., USA, Middle East, and Australia) corresponding to a particular level of probability of dissatisfaction (e.g., 0.2 level, 0.13 level, etc.). For example, to maintaining the probability of dissatisfaction at or below the 0.2 level, respective TAT thresholds can be determined from PDP 410. As another example, to maintaining the probability of dissatisfaction at or below the 0.13 level, respective responsiveness thresholds can be determined from PDP 430.

This new solution is advantageous compared to conventional approaches for setting up a blanket threshold. In comparison, the disclosed solution can enable an IT system to deliver services to all segments of users consistently at a target satisfaction or dissatisfaction level while the conventional IT systems would fail to do so. For example, a blanket threshold of ten days of TAT would lead to different probabilities of dissatisfaction for different segments of users, for instance, about 0.25 in the USA, 0.1 in the Middle East, and 0.3 in Australia. Similarly, a blanket threshold of six days of responsiveness would also lead to different probabilities of dissatisfaction for different segments of users, for instance, about 0.15 in the USA, 0.07 in the Middle East, and 0.25 in Australia.

The disclosed technologies allow a reviewer to set thresholds based on a visual examination of PDPs manually. In general, after the curve in the PDP flattens out, the feature has no further impact on the probability of dissatisfaction. In one embodiment, a reviewer observes that the probability of dissatisfaction remains constant for Australia after around seven days, where there is no marginal change in the probability of dissatisfaction even if the TAT moves above seven days. The user may decide that if the TAT moves from one to three days for Australia, the probability of dissatisfaction moves from 0.1 to 0.2 or two times. Hence it is advisable to set a TAT target for Australian tickets between one to two days.

In some embodiments, as discussed in FIG. 1, threshold configurator 116 determines the target satisfaction or dissatisfaction level from the PDP data without user intervention. In one embodiment, threshold configurator 116 determines the maximum and the minimum levels of satisfaction or dissatisfaction from the PDP data first, then determines the target level, e.g., based on a mean of the maximum and the minimum levels or other arithmetic operations. In one embodiment, threshold configurator 116 determines the target level based on how the slope or gradient changes with the curve, such as the maximum absolute second derivative for the curve. For example, threshold configurator 116 may determine the target dissatisfaction level based on a significant slope change. For instance, the curve of Australia in PDP 410 has a sudden slope change to become zero at the 0.26 level. Accordingly, the target dissatisfaction for Australian users may be set at the 0.26 level because TAT only has a diminished impact on the probability of dissatisfaction after such slope change.

Threshold configurator 116 can also determine respective feature thresholds (e.g., TAT or responsiveness thresholds) corresponding to the target satisfaction or dissatisfaction level from the PDP data without user intervention. As the PDP data reflects the function between the feature (e.g., TAT, responsiveness, etc.) and the predicted probabilities of satisfaction or dissatisfaction, threshold configurator 116 can easily derive respective feature thresholds (e.g., TAT or responsiveness thresholds) corresponding to the target satisfaction or dissatisfaction level from the PDP data without user intervention, e.g., the X-axis intercept in the PDP for corresponding to target dissatisfaction level.

In various embodiments, threshold configurator 116 harmonizes various feature thresholds. The harmonization process includes a process to determine the dominant feature threshold when there is an overall target satisfaction or dissatisfaction level. For example, the TAT threshold refers to the total time taken to resolve a ticket, while the responsiveness threshold refers to the average time taken to respond to incoming communication during the entire life cycle of the ticket. If the overall target level is 0.2 for USA users, the TAT threshold will point to six days, but the responsiveness threshold would point to ten days. In this case, threshold configurator 116 will determine the TAT threshold as the dominant feature threshold. Accordingly, SLD system 100 will act based on the dominant feature threshold, e.g., generating alerts or execute regulation tasks based on the dominant feature threshold. In some embodiments, threshold configurator 116 selects the PDP with the highest slope to determine the dominant feature threshold as higher slopes generally indicate rapid changes or a higher rate of impact on user satisfaction or dissatisfaction.

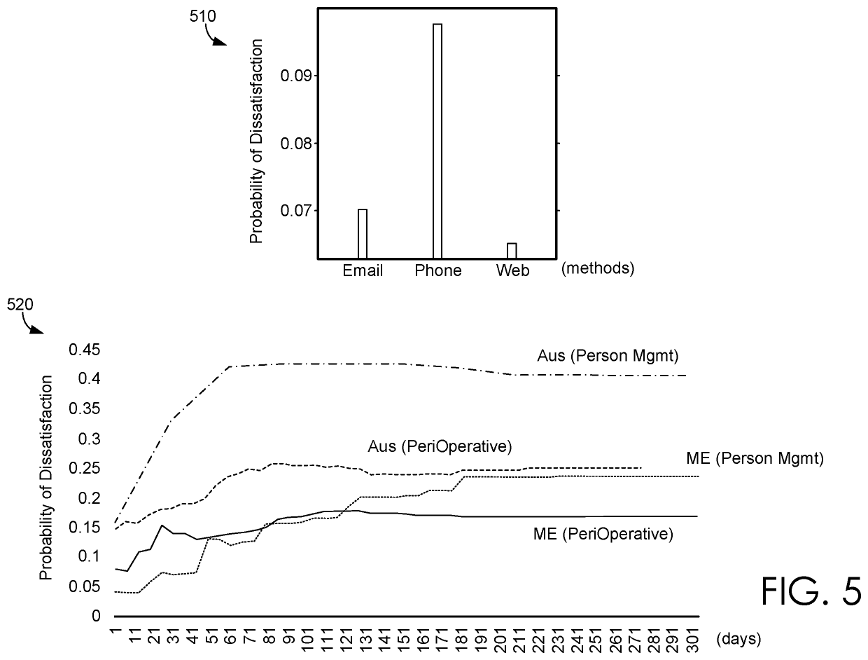

FIG. 5 depicts other forms of partial dependence plots. One-way PDPs show the interaction (e.g., linear, non-linear, etc.) between the target response and one target feature. PDP 510 and PDP 520 are both one-way PDPs. PDP 510 is a bar-based plot, while PDP 520 is a line-based plot.

PDP 510 reveals that the communication channel used on a ticket (e.g., over email, phone, or web) also matters to the probability of dissatisfaction. Notably, communication by phone has a higher impact, followed by email and web. Based on this PDP, this IT system should incentivize clients to use non-phone modes for logging issues since they provide a lower probability of dissatisfaction.

PDP 520 provides information on a deeper level about TAT's impact on user dissatisfaction. Here, the segments of users are defined by region and space together. PDP 520 reveals that the Middle East region generally has higher TAT thresholds compared to the Australian region. Meanwhile, higher TAT thresholds in the perioperative space are available compared to the person management space. Such knowledge can help support decisions in terms of staffing on the respective service teams. As an example, for similar incoming service volumes, the perioperative space can have a smaller support team or use less computational resources as compared to the person management space to reach the same target satisfaction level.

PDPs with two features show the interactions among the two features and the target response. Although not shown in FIG. 5, multivariate PDPs can be used to understand multiple variables. By way of example, multivariate PDPs can provide a visual indicator on the scale of change in satisfaction or dissatisfaction levels based on a combination of features. As another example, a multivariate PDP can be generated to understand the expectations of clients when logging issues through different mediums in terms of the TAT and the number of ownership changes. For instance, with one set of data, the multivariate PDP shows that a client who logs an issue through the web is seen to be more flexible regarding the number of ownership changes and the TAT on the ticket compared to Phone or Email. Similarly, people on email are more tolerant of having people involved if the TAT is below a given TAT threshold. Accordingly, more sophisticated rules (e.g., involving two or more features) may be generated according to a multivariate PDP for SLD.

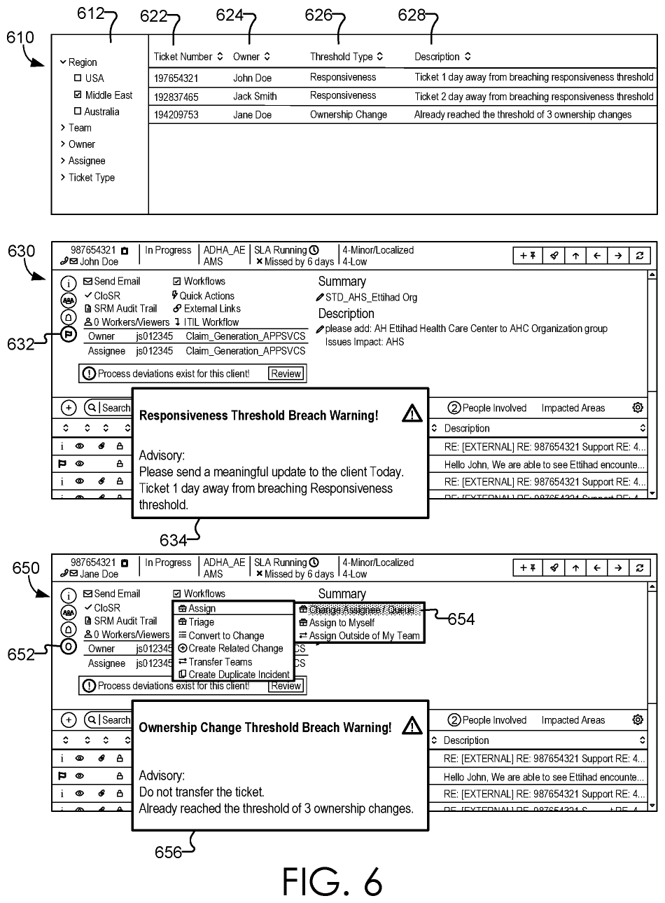

FIG. 6 shows exemplary graphical user interfaces for displaying alerts and relevant information. With GUI 610, the disclosed system can generate different alert summaries, e.g., based on one or more search/filter criteria, e.g., as shown in panel 612. By way of example, an operator of the disclosed system may select different filters under regions, teams, owners, assignees, ticket types, etc. Accordingly, all alerts meeting the search/filter criteria will be shown on the right panel of GUI 610. The displayed alerts may be further sorted based on, e.g., ticket number 622, owner 624, threshold type 626, description 628, etc. A person skilled in the art can appreciate that GUI 610 is merely an exemplary GUI, and different search/filter criteria or sorting fields can be designed and implemented depending on the needs of the specific IT system or SLD requirements.

With GUI 630, the disclosed system causes window 634 to display at an appropriate time. In general, the disclosed system is configured to alter the GUI to remind the operator of a system-generated alert, e.g., by placing a conspicuous symbol (e.g., symbol 632) before the service instance. This is a GUI improvement for SLD. In one embodiment, window 634 is triggered to display in response to a move-over event on symbol 632. In this way, the operator can quickly access alert information even without open the service instance. This is another GUI improvement for SLD. In another embodiment, window 634 would display when the operator opens the service instance, e.g., as shown in GUI 630. In other embodiments, the disclosed system may cause window 634 to display at an appropriate time, and the appropriate time may be determined based on the needs of the specific IT system or SLD requirements. This is a significant GUI improvement for SLD.

With GUI 650, the disclosed system causes window 656 to display in response to an event, which is another improvement over conventional systems or GUIs. In this case, the operator attempted to change ownership of the service instance via menu item 654. This even triggered the system to display window 656 because the ownership threshold would be breached if the ownership of this service instance changes again.

In some embodiments, the conspicuous symbols before the service instance are configured to reflect the type of alert. For example, symbol 652 is configured to reflect an alert related to “ownership change,” while symbol 632 is configured to reflect another alert related to “responsiveness.” In this way, the operator can intuitively grasp the nature of the alert and prioritize the review sequence accordingly. This is another GUI improvement for SLD.

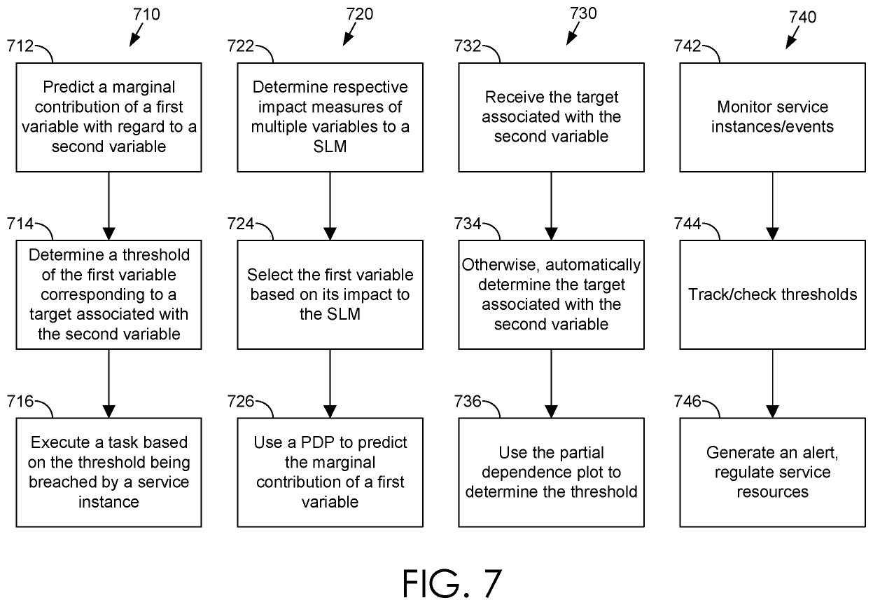

FIG. 7 are flow diagrams illustrating exemplary processes of service level delivery through partial dependence plots. These processes may be performed, e.g., by SLD system 100 of FIG. 1. Each block in FIG. 7, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be executed by a device, a standalone application or app, a computing service, or in any combinations thereof.

Process 710 is a general process of SLD based on PDPs. At block 712, the process predicts a marginal contribution of a first variable with regard to a second variable. In various embodiments, the first variable refers to a feature (e.g., TAT, responsiveness, etc.) that has a high-impact on the second variable, which refers to the SLM (e.g., user satisfaction or dissatisfaction). In some embodiments, the disclosed system uses a PDP to predict a marginal contribution of the first variable with regard to the second variable. The second variable includes various service levels, e.g., the 0.1 or 0.2 level of user dissatisfaction. The first variable (e.g., TAT, responsiveness, etc.) is an observable feature impacting the service level of user dissatisfaction. In some embodiments, the service level comprises a probability of dissatisfaction in relation to the first variable. In one embodiment, the first variable includes a turnaround time, which refers to an average duration for resolving service instances. In another embodiment, the first variable comprises a count of ownership changes, which refers to a count of different persons owning a service ticket. At least one embodiment related to block 712 is further described with process 720.

At block 714, the process determines a threshold of the first variable corresponding to a target associated with the second variable. In some embodiments, this block includes determining, via the PDP, a threshold of the first variable corresponding to a target probability of dissatisfaction associated with the second variable. Determining the threshold of the first variable comprises determining a value of the first variable corresponding to the target level of the second variable. Here, the target associated with the second variable (e.g., the 0.2 level of user dissatisfaction as discussed with FIG. 4) is determined by a system operator or automatically determined by the disclosed system without user intervention. Similarly, the threshold of the first variable corresponding to a target associated with the second variable may be determined by the system operator via the PDP or automatically determined by the disclosed system without user intervention from the PDP data. At least one embodiment related to block 712 is further described with process 730.

In one embodiment, this block includes determining, in relation to a target threshold of the second variable at the PDP, respective values of the first variable for the first curve, and the second curve. For example, in connection with FIG. 4, the disclosed system determines respective values (e.g., TAT values of intercepts 414, 416, and 418) of the first variable (e.g., TAT in PDP 410) for different curves (e.g., curves of the USA, the Middle East, Australia). In this example, the first curve corresponds to the first service area (e.g., the USA) with the first service team (e.g., the USA service team), and the second curve corresponds to the second service area (e.g., Australia) with the second service team (e.g., the Australia service team). Accordingly, in one embodiment, the disclosed system allocates, via a server, resources to respective service areas associated with the first curve and the second curve based on the respective values of the first variable for the first curve and the second curve. For example, in response to a global surge of service requests, the disclosed system may proportionally allocate computational or human resources to the three service areas (e.g., the USA, the Middle East, Australia) based on respective TAT thresholds. In general, the longer is the TAT threshold, the less computational or human resources may be needed to maintain a system-wide consistent level of user satisfaction. In continuance of the above example, the disclosed system may allocate more resources to the Australia service team than to the USA service team in response to the TAT threshold of Australia being less than the TAT threshold of the USA.

At block 716, the process executes a task based on the threshold being breached by a service instance. In some embodiments, this block includes causing the display of an alert on a GUI in response to a value of the first variable of a service instance being within a distance to the threshold of the first variable. Within a distance to the threshold of the first variable refers to within an alert zone of the feature threshold. The status of being breached covers any cases of being breached within the alert zone of the feature threshold. For example, if the TAT threshold is ten days and the buffer is three days, then after the service instance becomes seven days old, the disclosed system may label the service instance for breaching the TAT threshold. In response to the threshold being breached by the service instance, the disclosed system will generate and display an alert or execute relevant regulation tasks based on the SLD requirement, e.g., to maintain the 0.2 level of user dissatisfaction. At least one embodiment related to block 716 is further described with process 730.

Process 720 describes at least one embodiment related to block 712. At block 722, the process determines the respective impact measures of multiple variables to an SLM. In some embodiments, this block includes determining, based on an ensemble learning method, respective impact measures of variables associated with service data with user feedback, and ranking the variables based on the respective impact measures. For example, as discussed with FIG. 2, the prediction model is used to determine respective impact measures of multiple features (e.g., TAT, responsiveness, ownership changes, etc.) in relation to user dissatisfaction.

At block 724, the process selects the first variable based on its impact on the SLM. In some embodiments, this block includes selecting the first variable from the plurality of variables for the partial dependence plot based on the first variable being a top-ranked variable among the plurality of variables. PDPs typically only involve one or two feature variables and how their relationship with the predicted response (e.g., the predicted level of user dissatisfaction). Feature variables with trivia impact on the SLM are not useful for making PDPs. In various embodiments, only features having a high impact, e.g., the top two or three high-impact features, are selected in this block for making PDPs.

At block 726, the process uses a PDP to predict the marginal contribution of the first variable. In some embodiments, additional data generated from the prediction model (e.g., the additional data as shown in table 320 in FIG. 3) are used to produce the PDP data (e.g., data in table 330 in FIG. 3). Such PDP data may then be used to construct PDPs.

Process 730 describes at least one embodiment related to block 714. At block 732, the process receives the target associated with the second variable. At block 734, the process automatically determines the target associated with the second variable without user intervention in alternative embodiments. Collectively, block 732 and block 734 include receiving the target level of the second variable as user input or automatically determining the target level of the second variable based on a gradient associated with the partial dependence plot at the target level of the second variable.

In some embodiments, a system operator manually configures the target level of user dissatisfaction. As this type of sophisticated SLM may be negotiated in an SLA, the system operator may leverage from the information revealed in the PDPs to determine a reasonable and attenable target level of the SLM. In various embodiments, information of the slope or gradient of the curves in PDPs is used by the disclosed system to automatically determine the target associated with the second variable without user intervention, as discussed in FIG. 4. In some embodiments, such automatically determined values may be provided to the system operator for reference or serve as another data point for the system operator to determine the final target.

At block 736, the process uses the PDP to determine the feature threshold. In some embodiments, intercepting lines corresponding to different levels of the SLM are used in PDPs to determine the feature threshold. For example, an intercepting line corresponding to the 0.2 level of user dissatisfaction is used in FIG. 4. Those intercepts, where the intercepting line meets different curves, represent respective feature thresholds for respective curves. In some embodiments, the intercepting lines or intercepts are implemented in various mathematical models. The disclosed system can then directly compute respective feature thresholds from the PDP data based on the actual mathematical model.

Process 740 describes at least one embodiment related to block 716. At block 742, the process monitor service instances and related events. For example, in connection with FIG. 6, the disclosed system is configured to monitor those listed service instances and user interaction events with GUIs. At block 744, the process tracks and checks feature thresholds. Let us continue with the exemplarity GUIs in FIG. 6. In one embodiment, when a service instance is loaded to one of the GUIs, the disclosed system will retrieve any related alerts and cause them to be displayed. In another embodiment, when a service instance is loaded to one of the GUIs, the disclosed system will check whether any one of the service instances is going to breach any one of the tracked feature thresholds. If there is a breaching event, the disclosed system will generate an alert in block 746. In another embodiment, in response to a GUI-related event, such as an activation of a menu item (e.g., menu item 654), the disclosed system checks whether the underlying action associated with the menu item will breach the feather threshold associated with the menu item.

At block 746, the process generates an alert or regulates service resources. In some embodiments, causing display of an alert comprises causing display of a pop-up window (e.g., window 634, window 656) to show the alert when the service instance is activated on the graphical user interface. In some embodiments, causing display of the alert comprises causing display of a special symbol (e.g., symbol 632, symbol 652) next to the service instance on the GUI. In some embodiments, causing display of the alert comprises causing display of the alert among various alerts associated with respective service instances that are sortable on the GUI based on threshold types, e.g., as shown in GUI 610. Various other embodiments for generating alerts and regulating service resources are discussed in connection with this and previous figures.

Accordingly, various aspects of the technologies for generating layout variations have been disclosed herein. It is understood that various features, sub-combinations, and modifications of the embodiments described herein are of utility and may be employed in other embodiments without reference to other features or sub-combinations. Moreover, the order and sequences of steps/blocks shown in the above example processes are not meant to limit the scope of the present disclosure in any way, and in fact, the steps/blocks may occur in a variety of different sequences within embodiments hereof. Such variations and combinations thereof are also contemplated to be within the scope of embodiments of this disclosure.

Referring to FIG. 8, an exemplary operating environment for implementing various aspects of the technologies described herein is shown and designated generally as computing device 800. Computing device 800 is but one example of a suitable computing environment and is not intended to suggest any limitation as to the scope of use of the technologies described herein. Neither should the computing device 800 be interpreted as having any dependency or requirement relating to any one or combination of components illustrated.

The technologies described herein may be described in the general context of computer code or machine-useable instructions, including computer-executable instructions such as program components being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote processing devices that are connected through a communications network.

With continued reference to FIG. 8, computing device 800 includes a bus 810 that directly or indirectly couples the following devices: memory 820, processors 830, presentation components 840, input/output (I/O) ports 850, I/O components 860, and an illustrative power supply 870. Bus 810 may include an address bus, data bus, or a combination thereof. Although the various blocks of FIG. 8 are shown with lines for the sake of clarity, delineating various components is not so clear in various embodiments, and metaphorically, the lines would more accurately be grey and fuzzy. For example, one may consider a presentation component, such as a display device, to be an I/O component. The inventors hereof recognize that such is the nature of the art and reiterate that the diagram of FIG. 8 is merely illustrative of an exemplary computing device that can be used in connection with different aspects of the technologies described herein. The distinction is not made between such categories as “workstation,” “server,” “laptop,” “handheld device,” etc., as all are contemplated within the scope of FIG. 8 and refers to “computer” or “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technologies for storage of information such as computer-readable instructions, data structures, program modules, or other data.

Computer storage media includes RAM, ROM, EEPROM, flash memory or other memory technologies, CD-ROM, digital versatile disks (DVD) or other optical disk storage, magnetic cassettes, magnetic tape, magnetic disk storage, or other magnetic storage devices. Computer storage media does not comprise a propagated data signal. A computer-readable device or a non-transitory medium in a claim herein excludes transitory signals.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 820 includes computer storage media in the form of volatile and/or nonvolatile memory. The memory 820 may be removable, non-removable, or a combination thereof. Exemplary memory includes solid-state memory, hard drives, optical-disc drives, etc. Computing device 800 includes processors 830 that read data from various entities such as bus 810, memory 820, or I/O components 860. Presentation component(s) 840 present data indications to a user or another device. Exemplary presentation components 840 include a display device, speaker, printing component, vibrating component, etc. I/O ports 850 allow computing device 800 to be logically coupled to other devices, including I/O components 860, some of which may be built-in.

In various embodiments, memory 820 includes, in particular, temporal and persistent copies of SLD logic 822. SLD logic 822 includes instructions that, when executed by processor 830, result in computing device 800 performing functions, such as but not limited to, process 710, process 720, process 730, process 740, their respective sub-processes, or other processes described herein. In various embodiments, SLD logic 822 includes instructions that, when executed by processors 830, result in computing device 800 performing various functions associated with, but not limited to various components in connection with SLD system 100 in FIG. 1, such as data learner 112, PDP plotter 114, threshold configurator 116, threshold tracker 122, event monitor 124, and task runner 126.

In some embodiments, processors 830 may be packed together with SLD logic 822. In some embodiments, processors 830 may be packaged together with SLD logic 822 to form a System in Package (SiP). In some embodiments, processors 830 can be integrated on the same die with SLD logic 822. In some embodiments, processors 830 can be integrated on the same die with SLD logic 822 to form a System on Chip (SoC).

Illustrative I/O components include a microphone, joystick, gamepad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 830 may be direct or via a coupling utilizing a serial port, parallel port, system bus, or other interface known in the art. Furthermore, the digitizer input component may be a component separate from an output component, such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technologies described herein.

I/O components 860 include various GUIs, which allow users to interact with computing device 800 through graphical elements or visual indicators, such as various graphical elements illustrated in FIG. 6. Interactions with a GUI are usually performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, the same GUI may have different presentations on different computing devices, such as based on the different graphical processing units (GPUs) or the various characteristics of the display.

Computing device 800 may include networking interface 880. The networking interface 880 includes a network interface controller (NIC) that transmits and receives data. The networking interface 880 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 880 may include a wireless terminal adapted to receive communications and media over various wireless networks. Computing device 800 may communicate with other devices via the networking interface 880 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein have been described in relation to particular aspects, which are intended in all respects to be illustrative rather than restrictive. While the technologies described herein are susceptible to various modifications and alternative constructions, certain illustrated aspects thereof are shown in the drawings and have been described above in detail. It should be understood, however, that there is no intention to limit the technologies described herein to the specific forms disclosed, but on the contrary, the intention is to cover all modifications, alternative constructions, and equivalents falling within the spirit and scope of the technologies described herein.

What is claimed is:

1. A computer-readable storage device encoded with instructions that, when executed, cause a computing system to perform operations, comprising:
using a partial dependence plot to predict a marginal contribution of a first variable with regard to a second variable, the second variable being reflective of a service level, the first variable being an observable feature impacting the service level;
determining, via the partial dependence plot, a threshold of the first variable corresponding to a target probability of dissatisfaction associated with the second variable, wherein determining the threshold of the first variable comprises determining a value of the first variable corresponding to a target level of the second variable; and
causing display of an alert on a graphical user interface in response to the value of the first variable of a service instance being within a distance to the threshold of the first variable.

2. The computer-readable storage device of claim 1, wherein the instructions that, when executed, further cause the computing system to perform operations comprising:
determining, based on an ensemble learning method, respective impact measures of a plurality of variables associated with service data with user feedback;
ranking the plurality of variables based on the respective impact measures; and
selecting the first variable from the plurality of variables for the partial dependence plot based on the first variable being a top-ranked variable among the plurality of variables.

3. The computer-readable storage device of claim 1, wherein the instructions that, when executed, further cause the computing system to perform operations comprising:
receiving the target level of the second variable as a user input or automatically determining the target level of the second variable based on a gradient associated with the partial dependence plot at the target level of the second variable.

4. The computer-readable storage device of claim 1, wherein causing display of the alert comprises causing display of a pop-up window to show the alert when the service instance is activated on the graphical user interface.

5. The computer-readable storage device of claim 1, wherein causing display of the alert comprises causing display of a special symbol next to the service instance on the graphical user interface, the special symbol being indicative of a type of the alert.

6. The computer-readable storage device of claim 1, wherein causing display of the alert comprises causing display of the alert among a plurality of alerts associated with respective service instances that are sortable on the graphical user interface based on threshold types.

7. The computer-readable storage device of claim 1, wherein the service level comprises a probability of dissatisfaction in relation to the first variable, the first variable comprises a turnaround time, the turnaround time being an average duration for resolving service instances.

8. The computer-readable storage device of claim 1, wherein the service level comprises a probability of dissatisfaction in relation to the first variable, the first variable comprises a count of ownership changes, the count of ownership changes being a count of different persons owning a service ticket.

9. A computer-implemented method, comprising:
predicting, via a partial dependence plot, a marginal contribution of a first variable with regard to a second variable, the second variable being reflective of a service level, the first variable being an observable feature impacting the service level;
determining, in relation to a target threshold of the second variable at the partial dependence plot, respective values of the first variable for a first curve and a second curve; and
allocating, via a server, resources to respective service areas associated with the first curve and the second curve based on the respective values of the first variable for the first curve and the second curve.

10. The method of claim 9, further comprising:
determining, based on an ensemble learning method, respective impact measures of a plurality of variables associated with service data with user feedback;
ranking the plurality of variables based on the respective impact measures; and
selecting the first variable from the plurality of variables for the partial dependence plot based on the first variable being a top-ranked variable among the plurality of variables.

11. The method of claim 9, wherein the target threshold of the second variable comprises a probability of customer dissatisfaction, the first variable comprises a turnaround time.

12. The method of claim 9, wherein the respective values of the first variable comprises a first value of the first curve and a second value of the second curve corresponding to the target threshold of the second variable, wherein allocating comprises allocating more resources to a first service area corresponding to the first curve than to a second service area corresponding to the second curve in response to the first value being less than the second value.

13. The method of claim 9, wherein the first curve corresponds to a first service area, and the second curve corresponds to a second service area.

14. The method of claim 13, further comprising:
causing display of a first alert on a graphical user interface in response to a first value of the first variable of a first service instance in the first service area being surpassing the first value of the first curve; and
causing display of a second alert on the graphical user interface in response to a second value of the first variable of a second service instance in the second service area being surpassing the second value of the second curve.

15. The method of claim 14, wherein causing display of the first alert comprises causing display of a pop-up window to show the first alert when the first service instance is activated on the graphical user interface.

16. The method of claim 14, wherein causing display of the second alert comprises causing display of a special symbol next to the second service instance on the graphical user interface.

17. The method of claim 9, wherein the allocating comprises automatically allocating computing resources to the respective service areas.

18. A computer system, comprising:
means for predicting a marginal contribution of a first variable with regard to a second variable, the second variable being reflective of a service level, the first variable being an observable feature impacting the service level;
means for determining a threshold of the first variable corresponding to a target probability of dissatisfaction associated with the second variable; and
means causing display of an alert on a graphical user interface in response to a value of the first variable of a service instance surpassing the threshold of the first variable.

19. The computer system of claim 18, wherein means for causing display of the alert comprises means for causing display of a pop-up window to show the alert in response to the service instance being activated on the graphical user interface.

20. The computer system of claim 18, wherein means for causing display of the alert comprises means for causing display of a special symbol next to the service instance on the graphical user interface.
